(19) United States
(12) Patent Application Publication
(10) Pub. No.: US 2002/0187664 A1
(43) Pub. Date: Dec. 12, 2002

(54) Socket assembly for integrated circuit packages

(76) Inventors: James V. Murphy, Warwick, RI (US); Xiaoyun Yao, Harleysville, PA (US)

Correspondence Address: G. ROGER LEE, Fish & Richardson P.C., 225 Franklin Street, Boston, MA, 02110-2804, US

(21) Appl. No.: 09/875,675

(22) Filed: Jun. 6, 2001

(51) Int. Cl. H01R 12/00

(52) U.S. Cl. 439/70

(57) ABSTRACT

A socket assembly includes an electrically insulative socket body having holes extending through the socket body and arranged in a predetermined footprint corresponding to the array of electrical connection regions of the integrated circuit package, and a first and a second plurality of electrically conductive terminals. Each of the plurality of electrically conductive terminals are disposed in a corresponding one of a group of holes in the socket body. The first and second plurality of conductive terminals have an outer surface with a first and a second retaining member formed thereon, respectively, to retain the electrically conductive terminals within a corresponding one of the holes. The first retaining member is positioned a first axial distance from an end of the first plurality of terminal pins and the second retaining member is positioned a second axial distance from an end of the first plurality of terminal pins, the second axial distance being different than the first axial distance.

### TECHNICAL FIELD

This invention relates to making connections between integrated circuit array packages (IC) and circuit boards.

### BACKGROUND

Adaptors and sockets are often used to intercouple electrical circuit components (e.g., integrated circuit packages) and terminals for mechanical and electrical connection to external components, such as those on a printed circuit (PC) or wire wrap board. Such adaptors and IC sockets are described in Advanced Interconnections Catalog No. 7 (available from 5 Energy Way, West Warwick, R.I. 02893). IC Sockets are used to allow particular types of IC packages to be interchanged without permanent connection to a circuit board. In general, they consist of a glass epoxy frame having pins which are used to electrically connect a PC board with an IC or other electrical component. They can be used as high density sockets, single-in line or dual-in line sockets, decoupling capacitor sockets, hybrid socket and board connectors, pin grid array sockets, as well as, J lead, gull-wing and leadless adaptors and sockets. More recently, sockets for use with ball grid array (BGA) and land grid array (LGA) packages have been developed to allow these packages to be non-permanently connected (e.g., for testing) to a circuit board.

### SUMMARY

The invention features a socket assembly of the type used for receiving an integrated circuit package having an array of electrical connection regions on a bottom surface of the integrated circuit (IC) package.

In a general aspect of the invention, the socket assembly includes an electrically insulative socket body having holes extending through the socket body and arranged in a predetermined footprint corresponding to the array of electrical connection regions of the IC package, and a first and a second electrically conductive terminals. Each of the electrically conductive terminals is disposed in a corresponding one of a group of holes in the socket body. The first and second conductive terminals have an outer surface with first and second retaining members formed thereon, respectively, to retain the terminal pins within a corresponding one of the holes. The first retaining member is positioned a first axial distance from an end of the first plurality of electrically conductive terminals and the second retaining member is positioned a second axial distance from an end of the second plurality of electrically conductive terminals. The second axial distance is different than the first axial distance.

Embodiments of this aspect of the invention may include one or more of the following features. Each of the first electrically conductive terminals and the second electrically conductive terminals include a generally cylindrical body portion and contact portion.

In particular embodiments, each of the first electrically conductive terminals includes a pair of first retaining members and each of the second electrically conductive terminals includes a pair of second retaining members. Each of a second one of the pair of first retaining members of the first electrically conductive terminals is spaced from a lower end of the first electrically conductive terminals by a distance in a range between 20% and 30% (e.g., approximately 50%) of the length of the first electrically conductive terminals. Similarly, each of a second one of the pair of second retaining members of the second electrically conductive terminals is spaced from an upper end of the second electrically conductive terminals by a distance in a range between 20% and 30% (approximately 50%) of the length of the second electrically conductive terminals.

The first group of holes in the socket body are disposed along an outer periphery of the socket body and the first electrically conductive terminals is larger than the second electrically conductive terminals. For example, in a preferred embodiment, the first electrically conductive terminals represents 35% to 65% of the electrically conductive terminals disposed in the socket body, and more preferably 50% to 55% of the electrically conductive terminals disposed in the socket body.

Each of the contact portions of the first electrically conductive terminals and the second electrically conductive terminals include circumferentially spaced resilient fingers having terminal ends which extend upwardly from the body portion. The terminal ends of the fingers are adapted to engage a pin terminal.

In another aspect of the invention, a method for providing a socket assembly for receiving an integrated circuit package having an array of electrical connection regions on a bottom surface of the integrated circuit package includes the following steps. An electrically insulative socket body is provided, the socket body having upper and lower surfaces and holes extending through the socket body between the upper and lower surfaces. The holes are arranged in a predetermined footprint corresponding to the array of electrical connection regions of the integrated circuit package. A first electrically conductive terminals is positioned within a corresponding one of a first group of the plurality of holes in the socket body. Each of the first plurality of electrically conductive terminals has an outer surface with a first retaining member formed thereon to retain the first electrically conductive terminals within a corresponding one of the first group of holes in the socket body. The first retaining member is positioned a first axial distance from an end of the first plurality of terminal pins. A second plurality of electrically conductive terminals is positioned within a corresponding one of a second group of holes in the socket body. Each of the second plurality of electrically conductive terminals has an outer surface with a second retaining member formed thereon to retain the second electrically conductive terminals within a corresponding one of the second group of the plurality of holes in the socket body. The second retaining member is positioned a second axial distance from an end of the second plurality of electrically conductive terminals the second axial distance being different than the first axial distance.

In essence, electrically conductive terminals with different configurations of retaining elements are selectively positioned within an array of holes of a support member. The different configurations of retaining elements apply different loads on the support member. By selectively positioning different groups of the terminals within the holes, loading is distributed across the support member such that bowing of the support member is minimized. With this approach, once the terminals are properly positioned within the support member, the ends of the terminals are coplanar, thereby ensuring a reliable mechanical and electrical connection of the terminals to corresponding connection points.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an exploded, somewhat diagrammatic, isometric view of an intercoupling component assembly for a ball grid array (BGA) package.

FIG. 2 is a top view of a socket assembly of the intercoupling component assembly of FIG. 1.

FIG. 3 is a side view of the socket assembly of FIG. 2.

FIG. 4 is an enlarged side view of a portion of the socket assembly of FIG. 3.

FIGS. 5A-5B are side views (partially in cross section) of socket terminals of different construction for use with the socket assembly of FIG. 2.

### DETAILED DESCRIPTION

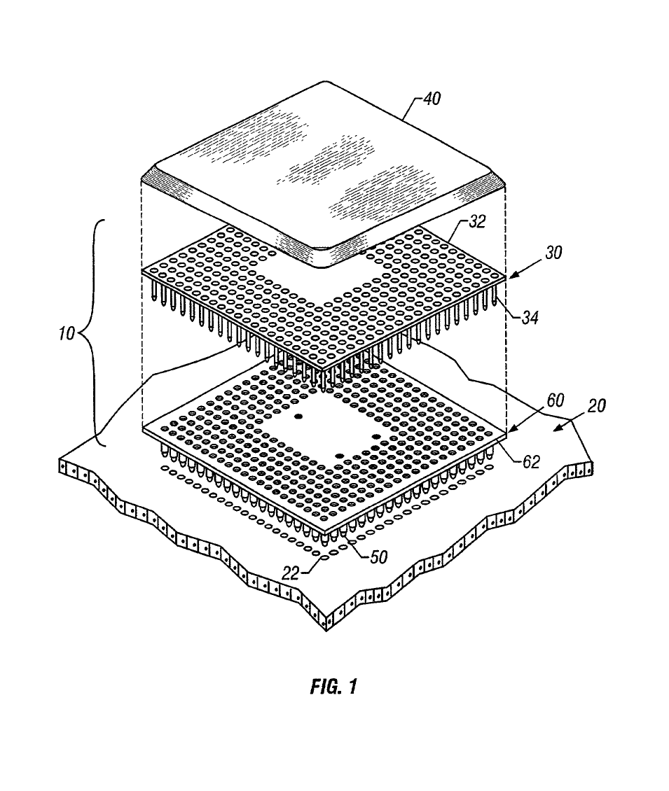

Referring to FIG. 1, an intercoupling component 10 is shown positioned to be connected to surface mount pads 22 of a printed circuit board 20. Adapter/socket assembly 10 includes a pin adapter 30 having an electrically insulative member 32 supporting pin terminals 34 positioned within an array of holes formed in member 32 in a pattern corresponding to a footprint of rounded solder balls (not shown) of a BGA package 40. When the solder balls of BGA package 40 are soldered to pin terminals 34 of pin adapter 30, the BGA package is converted to a high density pin grid array (PGA). Pin terminals 34 are received within socket terminals 50a, 50b of a socket assembly 60.

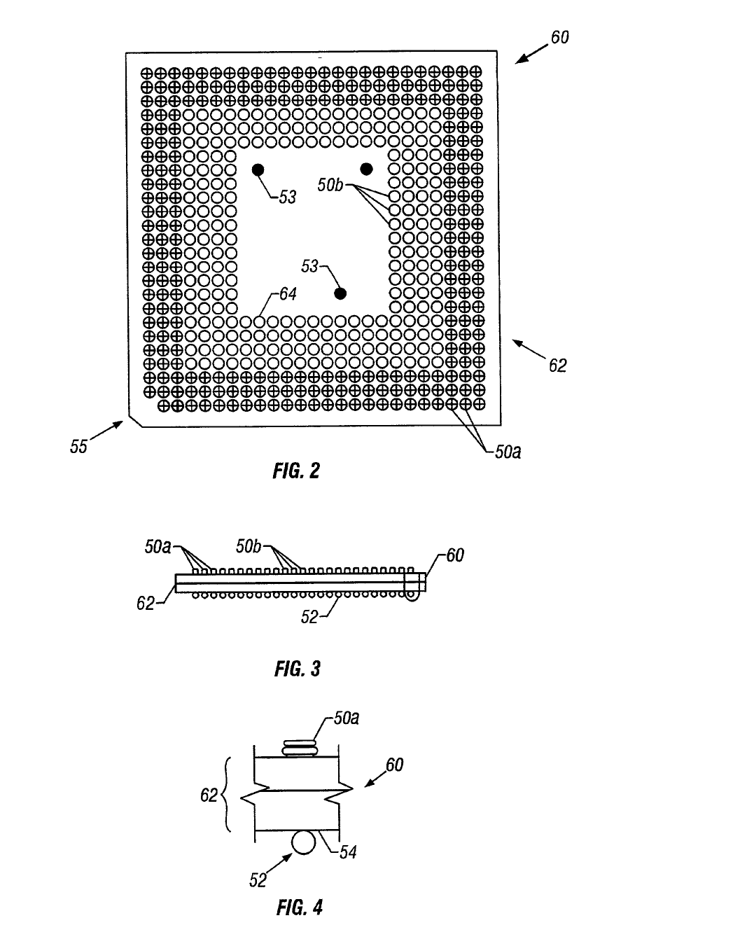

Referring to FIGS. 2 and 3, socket assembly 60 includes an insulative support member 62 for supporting the socket terminals positioned within an array of holes in a pattern corresponding to the footprint of the surface mount pads 22. Insulative support member 62 is formed of a relatively rigid thermoplastic and includes tooling holes 53 to facilitate manipulation of the socket 60 during assembly. One thermoplastic well suited for use in fabricating insulative support member 62 is a glass fiber reinforced and mineral-filled polypheylene sulfide (PPS). Glass fiber reinforced and mineral-filled PPS has a coefficient of thermal expansion (CTE) characteristic that is relatively close to the CTE of materials used for manufacturing the printed circuit boards commonly used with intercoupling component 10, such as a glass epoxy laminate. For reasons that will be described in greater detail below, socket terminals 50a are structured differently than socket terminals 50b.

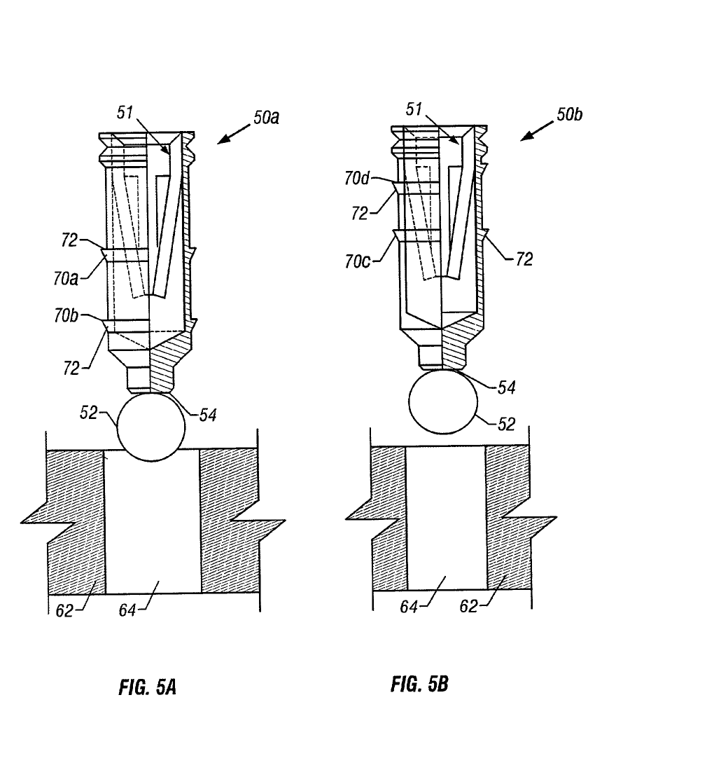

Referring to FIG. 4, in this embodiment, each socket terminal 50a, 50b includes a solder ball 52 preattached to its bottom end 54 (FIGS. 5A and 5B) to provide an identical mating condition to lands 22 as would have been the case had BGA package 40 been connected directly to the printed circuit board. In other applications, solder balls may be attached to pin terminals, such as those described in U.S. Pat. No. 6,007,348, entitled “Solder Ball Terminal,” issued Dec. 28, 1999, assigned to the assignee of the present invention, and incorporated herein by reference.

Referring again to FIG. 2, socket assembly 60 includes an array of sockets terminals, in which the three outermost rows of socket terminals along each side of the array have a configuration that is different than a configuration of the remaining socket terminals. For reasons that will be described in greater detail below, using socket terminal of different configurations minimizes the likelihood that insulative member 62 will bend. Thus, the surfaces of the insulative member and the contact surface of the terminals loaded therein have a greater likelihood of maintaining coplanarity.

Referring to FIGS. 5A and 5B socket terminals 50a, 50b include barb-like rings 70 formed on the outer cylindrical surface of the terminals and serve to retain the socket terminals members within holes of insulative member 62.

As shown in FIG. 5A, socket terminal 50a includes a pair of rings 70a, 70b, which extend entirely around the periphery of the socket terminal. Each ring has an outer contact surface 72 for engaging the inner wall of hole 64 of insulative support member 62. Contact surface 72 tapers inwardly, relative to a longitudinal axis of the socket, to facilitate insertion and provide a friction fit between the socket terminal and hole. Ring 70a is formed approximately half the length of the socket terminal, while ring 70b is formed between ring 70a and bottom end 54 of the socket terminal.

As shown in FIG. 5B, socket terminal 50b includes a pair of rings 70c, 70d which are similarly formed on the outer surface of the terminal and have the same tapered contact surface of socket terminal 50a. Ring 70c of socket terminal 50b, like ring 70a of socket terminal 50a, is formed about midway along the length of the socket terminal. However, ring 70d is formed between ring 70c and the upper end (where the pin terminal is received) of socket terminal 50b.

A fully loaded socket assembly (i.e., one having a large number of terminals positioned with the support member) is subjected to significant stresses. Although insulative member 62 is formed of a relatively rigid material, the force imparted by the individual terminals on the insulative member loaded within its holes imparts a significant amount of force to the member. For example, forces generated by socket terminals 50a uniformly loaded within an insulative member of a socket assembly would cause the outer edges to bend upwardly. In other words, the insulative support member would be bowed leaving a depression in the centermost region of the socket assembly.

In general, ring 70a of terminal 50a and ring 70c of terminal 50b are positioned near a midpoint along the length of the terminals. For example, it is generally preferable to position rings 70a, 70c a distance relative to the upper end of terminals 50a, 50b that is 40%-60% of the entire length of the terminals. Ring 70b of terminal 50a is positioned between ring 70a and the lower end of the terminal 50a is positioned between ring 70a and the lower end of the terminal for example, 20%-30% of the entire length, relative to the bottom end.

Similarly, ring 70d of terminal 50b is positioned between ring 70c and the upper end of terminal. In particular ring 70d is spaced from the upper end of terminal 50b by a distance 20%-30% of its entire length.

In the particular embodiment described above in conjunction with FIGS. 1-5A, 5B, insulative member 62 is approximately 35 mm square and has a thickness of approximately 2.4 mm. Insulative member 62 includes an array of five-hundred and three (503) holes 64, equally spaced from each other by a distance of approximately 1.3 mm. Rings 70a and 70b of socket terminals 50a positioned along the outer regions of support member 62) are approximately 1.35 mm and approximately 2.16 mm from the upper end of the socket terminal, respectively. On the other hand, rings 70c and 70d of socket terminals 50b (positioned within the centermost region of support member 62) are approximately 0.71 mm and approximately 1.32 mm from the upper end of the socket terminal, respectively.

Socket terminals 50a, 50b are of the type having spring contacts which receive and electrically contact pin terminals 34 of pin adapter 30. Further details of the structure and operation of spring contacts 51 in other socket terminals can be found in U.S. Pat. No. 5,877,554, entitled “Converter Socket Terminal,” issued Mar. 2, 1999, assigned to the assignee of the present invention, and incorporated herein by reference.

Other embodiments are within the scope of the claims. For example, it is appreciated that in other embodiments, the dimensions of the insulative member, as well as the overall number and spacing of socket terminals may differ. Thus, the relative position and spacing of the rings on the individual socket terminals may be adjusted to better distribute the forces imparted by the array of socket terminals. It is also appreciated that, although in the embodiment described above, two different socket terminal configurations were used, a greater number of configurations can be used within the same unit. For example, a third configuration of socket terminals could be provided within a group of holes positioned between the outermost and centermost holes.

Furthermore, although socket assembly 60 and its socket terminals 50a, 50b are of the type which provide a non-permanent connection between BGA packages and a printed circuit board, other configurations are within the scope of the claims. For example, the general concept of positioning terminals (e.g., male pins or female sockets) having different configurations for minimizing bending or bowing of a support member for a pin grid array and land grid array is within the scope of the claims.

What is claimed is:

1. A socket assembly for receiving an integrated circuit package having an array of electrical connection regions on a bottom surface of the integrated circuit package, the socket assembly comprising:
an electrically insulative socket body having upper and lower surfaces and a plurality of holes extending through said socket body between said upper and lower surfaces, said plurality of holes being arranged in a predetermined footprint corresponding to the array of electrical connection regions of the integrated circuit package;
a first plurality of electrically conductive terminals, each of the first plurality of electrically conductive terminals disposed in a corresponding one of a first group of the plurality of holes in the socket body, each of the first plurality of electrically conductive terminals having an outer surface with a first retaining member formed thereon to retain one of the first plurality of electrically conductive terminals within a corresponding one of the first group of the plurality of holes in the socket body, the first retaining member positioned a first axial distance from an end of the first plurality of terminal pins; and
a second plurality of electrically conductive terminals, each of the second plurality of electrically conductive terminals disposed in a corresponding one of a second group of the plurality of holes in the socket body, each of the second plurality of electrically conductive terminals having an outer surface with a second retaining member formed thereon to retain one of the second plurality of electrically conductive terminals within a corresponding one of the second group of the plurality of holes in the socket body, the second retaining member positioned a second axial distance from an end of the first plurality of terminal pins, the second axial distance being different than the first axial distance.

2. The socket assembly of claim 1 wherein each of the first plurality of electrically conductive terminals and the second plurality of electrically conductive terminals include a generally cylindrical body portion and contact portion.

3. The socket assembly of claim 2 wherein each of the first plurality of electrically conductive terminals includes a pair of first retaining members and each of the second plurality of electrically conductive terminals includes a pair of second retaining members.

4. The socket assembly of claim 4 wherein each of a second one of the pair of first retaining members of the first plurality of electrically conductive terminals is spaced from a lower end of the first plurality of electrically conductive terminals by a distance in a range between 20% and 30% of the length of the first plurality of electrically conductive terminals and each of a second one of the pair of second retaining members of the second plurality of electrically conductive terminals is spaced from an upper end of the second plurality of electrically conductive terminals by a distance in a range between 20% and 30% of the length of the second plurality of electrically conductive terminals.

5. The socket assembly of claim 4 wherein each of a first one of the pair of first retaining members of the first plurality of electrically conductive terminals is spaced from an upper end of the first plurality of electrically conductive terminals by a distance substantially 50% of the length of the first plurality of electrically conductive terminals and each of a first one of the pair of second retaining members of the second plurality of electrically conductive terminals is spaced from an upper end of the second plurality of electrically conductive terminals by a distance substantially 50% of the length of the second plurality of electrically conductive terminals.

6. The socket assembly of claim 1 wherein the first group of the plurality of holes in the socket body are disposed along an outer periphery of the socket body.

7. The socket assembly of claim 2 wherein the first plurality of electrically conductive terminals is larger than the second plurality of electrically conductive terminals.

8. The socket assembly of claim 6 wherein the first plurality of electrically conductive terminals represents 35% to 65% of the electrically conductive terminals disposed in the socket body.

9. The socket assembly of claim 7 wherein the first plurality of electrically conductive terminals represents 50% to 55% of the electrically conductive terminals disposed in the socket body.

10. The socket assembly of claim 2 wherein each of the contact portions of the first plurality of electrically conductive terminals and the second plurality of electrically conductive terminals include a plurality of spaced resilient fingers having terminal ends which extend upwardly from the body portion, the terminal ends of the fingers adapted to engage one of the first plurality of pin terminals.

11. The socket assembly of claim 2 wherein said contact portion of said contact assembly includes a plurality of circumferentially spaced resilient fingers having terminal ends which extend upwardly from the body portion, the terminal ends of said fingers configured to engage one of the first plurality of pin terminals.

12. A method for providing a socket assembly for receiving an integrated circuit package having an array of electrical connection regions on a bottom surface of the integrated circuit package, the socket assembly comprising:
providing an electrically insulative socket body having upper and lower surfaces and a plurality of holes extending through said socket body between said upper and lower surfaces, said plurality of vias being arranged in a predetermined footprint corresponding to the array of electrical connection regions of the integrated circuit package;
positioning a first plurality of electrically conductive terminals within a corresponding one of a first group of the plurality of holes in the socket body, each of the first plurality of electrically conductive terminals having an outer surface with a first retaining member formed thereon to retain one of the first plurality of electrically conductive terminals within a corresponding one of the first group of the plurality of holes in the socket body, the first retaining member positioned a first axial distance from an end of the first plurality of terminal pins; and
positioning a second plurality of electrically conductive terminals within a corresponding one of a second group of the plurality of holes in the socket body, each of the second plurality of electrically conductive terminals having an outer surface with a second retaining member formed thereon to retain one of the second plurality of electrically conductive terminals within a corresponding one of the second group of the plurality of holes in the socket body, the second retaining member positioned a second axial distance from an end of the second plurality of electrically terminal conductive, the second axial distance being different than the first axial distance.

13. The method of claim 12 wherein each of the first plurality of electrically conductive terminals and the second plurality of electrically conductive terminals include a generally cylindrical body portion and contact portion.

14. The method of claim 13 wherein each of the first plurality of electrically conductive terminals includes a pair of first retaining members and each of the second plurality of electrically conductive terminals includes a pair of second retaining members.

15. The socket assembly of claim 14 wherein each of a second one of the pair of first retaining members of the first plurality of electrically conductive terminals is spaced from a lower end of the first plurality of electrically conductive terminals by a distance in a range between 20% and 30% of the length of the first plurality of electrically conductive terminals and each of a second one of the pair of second retaining members of the second plurality of electrically conductive terminals is spaced from an upper end of the second plurality of electrically conductive terminals by a distance in a range between 20% and 30% of the length of the second plurality of electrically conductive terminals.

16. The method of claim 15 wherein each of a first one of the pair of first retaining members of the first plurality of electrically conductive terminals is spaced from an upper end of the first plurality of electrically conductive terminals by a distance substantially 50% of the length of the first plurality of electrically conductive terminals and each of a first one of the pair of second retaining members of the second plurality of electrically conductive terminals is spaced from an upper end of the second plurality of electrically conductive terminals by a distance substantially 50% of the length of the second plurality of electrically conductive terminals.

17. The method of claim 12 comprising positioning the first group of the plurality of holes in the socket body along an outer periphery of the socket body.

18. The method of claim 13 wherein the first plurality of electrically conductive terminals is larger than the second plurality of electrically conductive terminals.

19. The method of claim 18 wherein the first plurality of electrically conductive terminals represents 35% to 65% of the electrically conductive terminals disposed in the socket body.

20. The method of claim 19 wherein the first plurality of electrically conductive terminals represents 50% to 55% of the electrically conductive terminals disposed in the socket body

21. The method of claim 13 wherein each of the contact portions of the first plurality of electrically conductive terminals and the second plurality of electrically conductive terminals include a plurality of spaced resilient fingers having terminal ends which extend upwardly from the body portion, the terminal ends of the fingers adapted to engage side portions of ball contacts of a ball grid array package seated on the upper surface of the socket body.

22. The method of claim 13 wherein said contact portion of said contact assembly includes a plurality of circumferentially spaced resilient fingers having terminal ends which extend upwardly from the body portion, the terminal ends of said fingers configured to engage a terminal pin.
